(19) United States
(12) Patent Application Publication
(10) Pub. No.: US 2026/0267898 A1
(43) Pub. Date: Sep. 10, 2026

(54) DAILY ACTIVITY SUMMARY PROVIDING SYSTEM AND METHOD

(71) Applicant: WONDERFUL PLATFORM LIMITED, Seoul (KR)

(72) Inventors: SEUNG YUB KOO, Gyeonggi-do (KR); SEONG TAEK HWANG, Gyeonggi-do (KR); JOON GU HEO, Seoul (KR); SU MIN KIM, Seoul (KR); HEE EUN JO, Seoul (KR)

(21) Appl. No.: 19/332,372

(22) Filed: Sep. 18, 2025

(30) Foreign Application Priority Data
Mar. 4, 2025 (KR) 10-2025-0027558

(51) Int. Cl. G06F 16/34

(52) U.S. Cl. CPC G06F 16/345

(57) ABSTRACT

A daily activity summary providing system includes an information collection unit configured to collect daily information while worn on a user or through interaction with the user, an information analysis unit configured to receive the collected daily information from the information collection unit and analyze the received daily information to generate analysis information, and a summary information generation unit configured to receive the generated analysis information from the information analysis unit and summarize the received analysis information by time or topic to generate the summary information. As a user's daily activities and health condition are collected in a natural manner through an information collection unit including a robot, a smart device or a healthcare device, and summary information is provided in a diary format, there is an effect of helping the user and caregiver easily understand the user's condition in daily life.

### CROSS-REFERENCE TO RELATED APPLICATION AND CLAIM OF PRIORITY

This application claims the benefit under 35 USC § 119 of Korean Patent Application No. 10-2025-0027558, filed on Mar. 4, 2025, in the Korean Intellectual Property Office, the entire disclosure of which is incorporated herein by reference for all purposes.

### BACKGROUND

### 1. Field

The present disclosure relates to a daily activity summary providing system and method.

### 2. Description of the Related Art

The present invention was supported by the national research and development program (Project identification number: 1415190005; Project number: P0025661; Department name: Ministry of Trade, Industry and Energy; Project management (professional) organization name: Korea Institute for Advancement of Technology; Research program title: Industrial Technology International Cooperation; Research project title: Human care solutions based on AI data analysis and monitoring systems; Contribution ratio: 100%; Project execution organization name; WONDERFUL PLATFORM LIMITED; Research period: 2023.07.01-2026.06.30 awarded by Ministry of Trade, Industry and Energy. The Government has certain rights in the invention.

Recently, as older population grows, more attention is being paid to daily health management and safety of seniors including older persons living alone.

In this circumstance, many different healthcare devices and services are being developed to monitor and record users' daily life patterns and health conditions.

Typically, there are technologies used to measure users' activity level, heart rate, blood pressure or blood sugar level through wearable devices such as smartwatches, blood pressure monitors or blood sugar monitors, and check the users' health conditions based on the measurements.

In addition, some care services combined with robotics technology adopt a system whereby robots inquire about users' conditions through voice conversations in the users' living spaces, ensure that the users take medication and send notifications to caregivers in case of emergency.

However, the existing technologies have the following limitations.

First, because health condition measurement data through healthcare devices and life record data through robots or mobile devices are separately managed, there are few or no services that combine data in an organized manner and record and provide users' daily flow in a full and comprehensive manner.

Second, because senior users may be bad at or unfamiliar with manipulating devices, there are concerns about inaccuracy and discontinuity in the data collection process.

Third, because data is simply listed after it is collected, it is often difficult for users to easily understand and utilize the data.

Accordingly, there is a need for development of technology that collects daily activities and health conditions of users, especially seniors through various devices in a natural manner and writes and provides user-friendly summaries to help the users and caregivers easily understand the users' conditions in daily life.

### SUMMARY

The present disclosure is designed to solve the above-described problems and therefore the present disclosure is directed to providing a daily activity summary providing system and method that collects daily activities and health condition of a user, for example, a senior in a natural manner through an information collection unit including a robot, a smart device or a healthcare device, and provides summary information in a diary format to help the user easily understand the user's condition in daily life and a caregiver efficiently check the user's condition at a remote location.

The present disclosure is further directed to providing a daily activity summary providing system and method that accurately records the overall situation of the user's daily life such as sleep, meals, exercise, emotional state or medication intake using a combination of various data collection means and manages it in a full and comprehensive manner, thereby contributing to the user's health management and life safety improvement.

The objectives of the present disclosure are not limited thereto, and these and other objectives will be clearly understood by those skilled in the art from the following description.

To achieve the above-described objectives, an embodiment of the present disclosure provides a daily activity summary providing system that collects daily information associated with a user's daily activities, analyzes the collected daily information and provides summary information, the system including an information collection unit to collect the daily information while worn on the user or through interaction with the user; an information analysis unit to receive the collected daily information from the information collection unit and analyze the received daily information to generate analysis information; and a summary information generation unit to receive the generated analysis information from the information analysis unit and summarize the received analysis information by time or topic to generate the summary information.

Additionally, provided is the daily activity summary providing system further including a summary information transmission unit to receive the generated summary information from the summary information generation unit and transmit the received summary information to the information collection unit or an external terminal device.

Additionally, provided is the daily activity summary providing system wherein the summary information generation unit includes a generative artificial intelligence model to summarize the analysis information by time including any one of day, week, month or year, or by topic to generate text information.

Meanwhile, another embodiment of the present disclosure provides a daily activity summary providing method that collects daily information associated with a user's daily activities, analyzes the collected daily information and provides summary information, the method including the steps of (a) collecting, by an information collection unit of a daily activity summary providing system, the daily information while worn on the user or through interaction with the user; (b) receiving, by an information analysis unit of the daily activity summary providing system, the collected daily information from the information collection unit and analyzing the received daily information to generate analysis information; and (c) receiving, by a summary information generation unit of the daily activity summary providing system, the generated analysis information from the information analysis unit and summarizing the received analysis information by time or topic to generate the summary information.

Additionally, provided is the daily activity summary providing method further including the step of (d) receiving, by a summary information transmission unit of the daily activity summary providing system, the generated summary information from the summary information generation unit and transmitting the received summary information to the information collection unit or an external terminal device.

Additionally, provided is the daily activity summary providing method wherein the summary information generation unit includes a generative artificial intelligence model to summarize the analysis information by time including any one of day, week, month or year, or by topic to generate text information.

According to an embodiment of the present disclosure, as the user's daily activities and health condition are collected in a natural manner through the information collection unit including a robot, a smart device or a healthcare device, and the summary information is provided in a diary format, there is an effect of helping the user and caregiver easily understand the user's condition in daily life.

Additionally, as the overall situation of the user's daily life such as sleep, meals, exercise, emotional state or medication intake is accurately recorded using a combination of various data collection means and managed in a full and comprehensive manner, there is an effect of supporting the user's health management and life safety more efficiently.

In particular, as information is provided to the user, for example, a senior struggling to manipulate devices in a natural manner through question and answer with the information collection unit or through the automated data collection process, there is an effect of improving accuracy and continuity of data collection.

Furthermore, as the summary of collected information is provided on daily/weekly/monthly/yearly basis, there is an effect of helping the user and caregiver understand long-term life and health changes quickly, thereby recognizing abnormal signs or bad health condition at the early stage.

### BRIEF DESCRIPTION OF THE DRAWINGS

FIG. 1 is a block diagram of a daily activity summary providing system according to an embodiment of the present disclosure.

FIG. 2 is a flowchart of a daily activity summary providing method according to another embodiment of the present disclosure.

FIG. 3 is a diagram showing an example of summary information provided in a daily diary format.

### DETAILED DESCRIPTION

Hereinafter, certain embodiments of the present disclosure will be described in detail through the exemplary drawings. In affixing the reference numerals to the elements in each drawing, it should be noted that identical elements are given as identical numbers as possible although they are depicted in different drawings. Additionally, in describing the present disclosure, when it is determined that a detailed description of a related known element or function may obscure the subject matter of the present disclosure, its detailed description is omitted.

Furthermore, in describing the elements of the present disclosure, the terms first, second, A, B, (a), (b), etc. may be used. These terms are used to distinguish one element from another, and the nature, sequence or order of the corresponding element is not limited by the term. When an element is referred to as being “connected to”, “coupled to” or “linked to” another element, it should be understood that it can be directly connected or linked to the other element, but another element may be “connected”, “coupled” or “linked” between the elements.

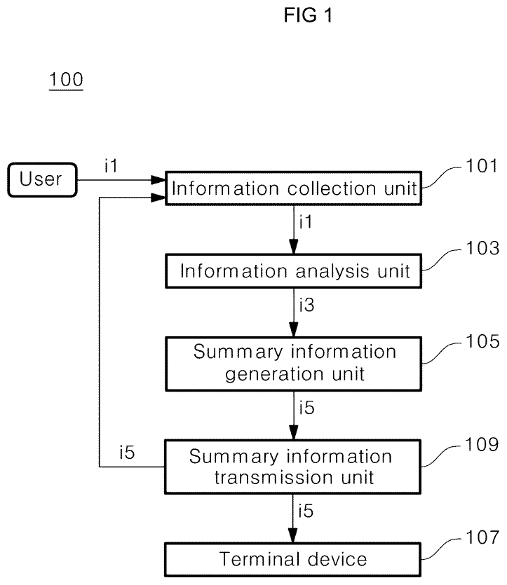

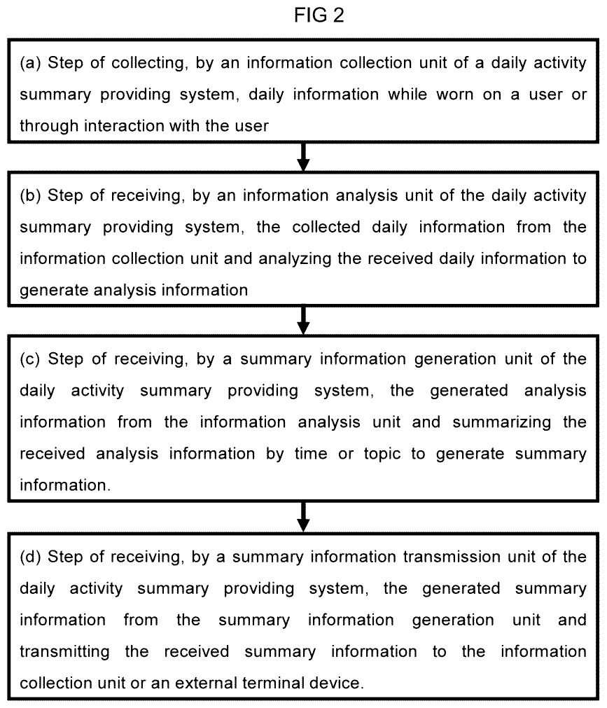

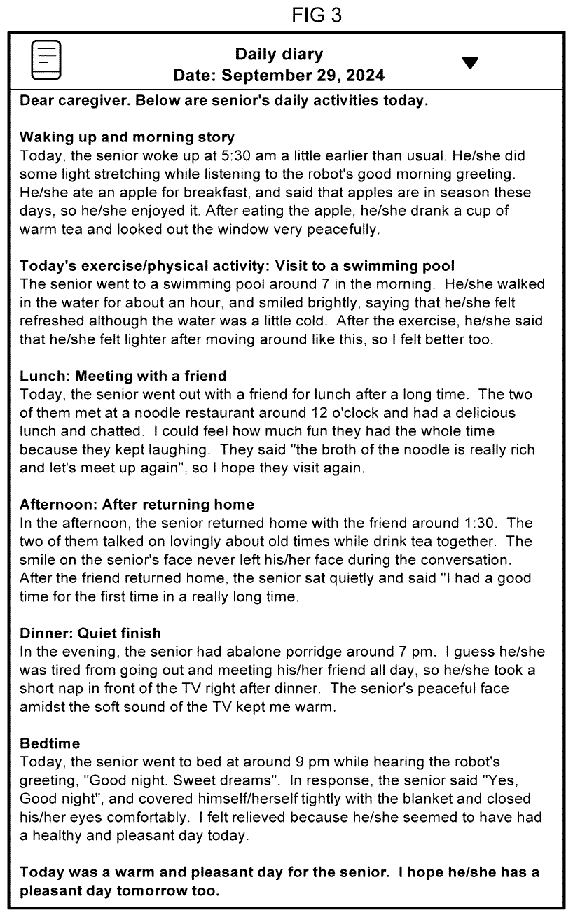

FIG. 1 is a block diagram of a daily activity summary providing system according to an embodiment of the present disclosure. FIG. 2 is a flowchart of a daily activity summary providing method according to another embodiment of the present disclosure. FIG. 3 is a diagram showing an example of summary information provided in a daily diary format.

As shown in FIGS. 1 to 3, according to an embodiment of the present disclosure, the system 100 that collects daily information (i1) associated with a user's daily activities, analyzes the collected daily information (i1) and provides summary information (i5) includes an information collection unit 101 to collect the daily information (i1) while worn on the user or through interaction with the user; an information analysis unit 103 to receive the collected daily information (i1) from the information collection unit 101 and analyze the received daily information (i1) to generate analysis information (i3); and a summary information generation unit 105 to receive the generated analysis information (i3) from the information analysis unit 103 and summarize the received analysis information (i3) by time or topic to generate the summary information (i5).

Hereinafter, each component will be described in detail.

### Information Collection Unit 101

The information collection unit 101 collects the daily information (i1) associated with the user's daily activities while worn on the user or through interaction with the user.

The information collection unit 101 worn on the user may include, for example, a smartwatch or a healthcare device (a blood pressure monitor, a blood sugar monitor and so on).

The information collection unit 101 that interacts with the user may include, for example, a smartphone, a tablet, a PC or a robot.

The daily information (i1) collected by the information collection unit 101 with regard to the user's daily activities may include, for example, videos or photos taken by the user by using the information collection unit 101, for example, the smartphone or the tablet, conversation (question/answer) with the robot, videos viewed by the user through the information collection unit 101, photos seen by the user through the information collection unit 101, information related to medication intake, information related to waking up/sleeping, information related to meals, information related to exercise entered by the user through the information collection unit 101, or information related to movement paths collected through the information collection unit 101.

### Information Analysis Unit 103

The information analysis unit 103 receives the collected daily information (i1) from the information collection unit 101.

The information analysis unit 103 analyzes the received daily information (i1) from the information collection unit 101 to generate the analysis information (i3).

The analysis information (i3) generated by analyzing the daily information (i1) by the information analysis unit 103 may include, for example, time information related to the time when the daily information (i1) was generated, the user's interest information and emotional information generated by analyzing the contents of the conversation (question/answer) with the robot, object information generated by analyzing the video and photo taken by the user, video and image information generated by analyzing the video and photo viewed or seen by the user, body monitoring information generated by analyzing the sensing data collected through the smartwatch or healthcare device (the blood pressure monitor, the blood sugar monitor and so on) worn on the user, or life pattern information generated by analyzing the user's medication intake-related information, waking up/sleeping-related information, meal-related information or exercise-related information.

### Summary Information Generation Unit 105

The summary information generation unit 105 receives the generated analysis information (i3) from the information analysis unit 103.

The summary information generation unit 105 summarizes the received analysis information (i3) from the information analysis unit 103 by time or topic to generate the summary information (i5).

For example, the summary information generation unit 105 may include a generative artificial intelligence (AI) model to summarize the contents of the analysis information (i3) by time including any one of day, week, month or year, or by topic to generate text information.

Here, the text information generated by the generative AI model may be, for example, written in a diary format.

The generative AI model may include, for example, the following components:
\textcircled{1} Natural Language Processing (NLP) Model

The natural language processing model may extract the meaning and understands the context by analyzing the interest information, the emotional information, the object information, the video information, the image information, the body monitoring information or the life pattern information, and may include, for example, Transformer-based models (GPT, BERT, T5 and so on).
\textcircled{2} Summarization Model

The summarization model may summarize the collected data into a diary format in a natural manner, and incorporate a combination of extractive summarization and abstractive summarization to provide a personalized summary based on the user's past data.
\textcircled{3} Personalized Style & Sentiment Analysis Model

The personalized style & sentiment analysis model may adjust the writing style based on the user's preference and emotional state (positive/negative), and record the user's emotional changes using sentimental analysis AI.
\textcircled{4} Multimodal Data Processing Model

The multimodal data processing model may analyze all different types of information such as voice, text, video or image or health data, and combine the body monitoring information (blood pressure, heart rate and so on) with the emotional information to generate a sentence, for example, “feel so good today”.
\textcircled{5} Real-time Self-Learning & Adaptation Model

The real-time self-learning & adaptation model may improve the summary quality based on continuous feedback (for example, changes provided by the user), and write the personalized diary more elaborately by AI-enabled learning of the user's pattern.

Meanwhile, according to an embodiment of the present disclosure, the system may further include a summary information transmission unit 109 to receive the generated summary information (i5) from the summary information generation unit 105 and transmit the received summary information (i5) to the information collection unit 101 or an external terminal device 107.

### Summary Information Transmission Unit 109

The summary information transmission unit 109 may include a wired or wireless communication module.

When the summary information (i5) is transmitted to the information collection unit 101 through the summary information transmission unit 109, the user may see the summary information (i5) through a display device included in the information collection unit 101.

Additionally, when the summary information (i5) is transmitted to the external terminal device 107 through the summary information transmission unit 109, a person (caregiver) who is connected to the user personally may see the summary information (i5) through the terminal device 107.

Meanwhile, according to another embodiment of the present disclosure, a method that collects the daily information (i1) associated with the user's daily activities, analyzes the collected daily information (i1) and provides the summary information (i5) includes the steps of: (a) collecting, by the information collection unit 101 of the daily activity summary providing system 100, the daily information (i1) while worn on the user or through interaction with the user; (b) receiving, by the information analysis unit 103 of the daily activity summary providing system 100, the collected daily information (i1) from the information collection unit 101 and analyzing the received daily information (i1) to generate the analysis information (i3); and (c) receiving, by the summary information generation unit 105 of the daily activity summary providing system 100, the generated analysis information (i3) from the information analysis unit 103 and summarizing the received analysis information (i3) by time or topic to generate the summary information (i5).

Additionally, the daily activity summary providing method according to another embodiment of the present disclosure may further include the step of (d) receiving, by the summary information transmission unit 109 of the daily activity summary providing system 100, the generated summary information (i5) from the summary information generation unit 105 and transmitting the received summary information (i5) to the information collection unit 101 or the external terminal device 107.

Additionally, in the daily activity summary providing method according to another embodiment of the present disclosure, the summary information generation unit 105 may include the generative AI model to summarize the analysis information (i3) by time including any one of day, week, month or year, or by topic to generate the text information.

The detailed description and function of each of the entities that perform the steps of the daily activity summary providing method according to another embodiment of the present disclosure are the same as those of the daily activity summary providing system 100, and its detailed description is omitted.

As has been described hereinabove, according to an embodiment of the present disclosure, as the user's daily activities and health condition are collected in a natural manner through the information collection unit including the robot, the smart device or the healthcare device, and the summary information is provided in a diary format, there is an effect of helping the user and caregiver easily understand the user's condition in daily life.

In addition, as the overall situation of the user's daily life such as sleep, meals, exercise, emotional state or medication intake is accurately recorded using a combination of various data collection means and managed in a full and comprehensive manner, there is an effect of supporting the user's health management and life safety more efficiently.

In particular, as information is provided to the user, for example, a senior struggling to manipulate devices in a natural manner through question and answer with the information collection unit or through the automated data collection process, there is an effect of improving accuracy and continuity of data collection.

Furthermore, as the summary of collected information is provided on daily/weekly/monthly/yearly basis, there is an effect of helping the user and caregiver understand long-term life and health changes quickly, thereby recognizing abnormal signs or bad health condition at the early stage.

Although all the elements in the embodiments of the present disclosure have been hereinabove described as being combined into one or working in combination, the present disclosure is not necessarily limited to these embodiments. That is, within the intended scope of the present disclosure, all the elements may be selectively combined into one or more and work in combination.

The technical aspects of the present disclosure are described by way of illustration, and it is obvious to persons having ordinary skill in the technical field pertaining to the present disclosure to make modifications and changes thereto without departing from the essential features of the present disclosure. Therefore, the disclosed embodiments of the present disclosure are provided to describe the technical aspects of the present disclosure, but not intended to be limiting, and the scope of the present disclosure is not limited by these embodiments. The scope of protection of the present disclosure should be interpreted by the appended claims, and it should be understood that all the technical aspects within the equivalent scope are included in the scope of protection of the present disclosure.

What is claimed is:

1. A daily activity summary providing system comprising:
an information collection unit configured to collect daily information while worn on a user or through interaction with the user;
an information analysis unit configured to receive the collected daily information from the information collection unit and analyze the received daily information to generate analysis information; and
a summary information generation unit configured to receive the generated analysis information from the information analysis unit and summarize the received analysis information by time or topic to generate the summary information.

2. The daily activity summary providing system according to claim 1, further comprising:
a summary information transmission unit configured to receive the generated summary information from the summary information generation unit and transmit the received summary information to the information collection unit or an external terminal device.

3. The daily activity summary providing system according to claim 1, wherein the summary information generation unit includes a generative artificial intelligence model to summarize the analysis information by time including any one of day, week, month or year, or by topic to generate text information.

4. A method for providing daily activity summary by a daily activity summary providing system, the method comprising:
collecting, by an information collection unit of the daily activity summary providing system, the daily information while worn on the user or through interaction with the user;
receiving, by an information analysis unit of the daily activity summary providing system, the collected daily information from the information collection unit and analyzing the received daily information to generate analysis information; and
receiving, by a summary information generation unit of the daily activity summary providing system, the generated analysis information from the information analysis unit and summarizing the received analysis information by time or topic to generate the summary information.

5. The daily activity summary providing method according to claim 4, further comprising the step of:
receiving, by a summary information transmission unit of the daily activity summary providing system, the generated summary information from the summary information generation unit and transmitting the received summary information to the information collection unit or an external terminal device.

6. The daily activity summary providing method according to claim 4, wherein the summary information generation unit includes a generative artificial intelligence model configured to summarize the analysis information by time including any one of day, week, month or year, or by topic to generate text information.
